(19) United States
(12) Patent Application Publication
(10) Pub. No.: US 2012/0155405 A1
(43) Pub. Date: Jun. 21, 2012

(54) APPARATUS AND METHOD FOR RECEIVING A RANDOM ACCESS CHANNEL FOR A WIRELESS COMMUNICATION SYSTEM

(75) Inventors: Hwa-Sun You, Seoul (KR); Yon-Woo Yoon, Anyang-si (KR)

(73) Assignee: SAMSUNG ELECTRONICS CO., LTD., Suwon-si (KR)

(21) Appl. No.: 13/331,642

(22) Filed: Dec. 20, 2011

(30) Foreign Application Priority Data
Dec. 20, 2010 (KR) 10-2010-0130601

(51) Int. Cl. H04W 74/08

(52) U.S. Cl. 370/329

(57) ABSTRACT

An apparatus and a method for receiving a random access signal in a base station of a wireless communication system are provided. The apparatus for receiving the signal includes a control signal extractor for extracting the random access signal from a signal received via an antenna, at least one sequence generator for generating at least one sequence by multiplying the random access signal by at least one candidate sequence, a sequence selector for selecting at least one sequence to detect by differentially correlating sequence components at an adjacent subcarrier location with respect to each sequence, and a detector for detecting the at least one selected sequence.

### CROSS-REFERENCE TO RELATED APPLICATION(S) AND CLAIM OF PRIORITY

The present application is related to and claims priority under 35 U.S.C. §119(a) to a Korean patent application filed in the Korean Intellectual Property Office on Dec. 20, 2010, and assigned Serial No. 10-2010-0130601, the entire disclosure of which is hereby incorporated by reference.

### TECHNICAL FIELD OF THE INVENTION

The present invention relates generally to wireless communication systems, and more particularly, to an apparatus and a method for receiving a random access channel in a wireless communication system.

### BACKGROUND OF THE INVENTION

A mobile station in a wireless communication system may request call access procedures such as initial network entry or hand-off to a base station using a random access channel. When the call access procedure of the mobile station is not fully completed, the mobile station is not assigned an identifier or a Caller IDentifier (CID) from the system and thus not allocated the resource. Accordingly, the mobile station requests the call access procedure to the base station using the random access channel.

When the call access procedure of the mobile station is not fully completed, the mobile station may only receive the downlink and thus its uplink synchronization is not guaranteed. Uplink synchronization delay is caused by Round Trip Delay (RTD) according to a distance to the base station.

The base station determines whether the mobile station transmits a random access sequence with respect to all receivable random access sequences. In doing so, the base station measures a synchronization error for the reception timing of each random access sequence and sends a synchronization correction command to each mobile station.

As stated above, the base station needs to determine whether the mobile station transmits the random access request with respect to all of the random access sequences. That is, when receiving a random access channel signal, the base station needs to determine whether the mobile station transmits as many times as the random access sequences allocated for the random access channel. Further, when determining whether the random access sequences allocated for the random access channel are transmitted, the base station applies an Inverse Fast Fourier Transform (IFFT) to the random access sequences allocated for the random access channel, which may increase complexity. For example, to lower the probability of a collision generated when mobile stations randomly select their random access channel, an Orthogonal Frequency Division Multiplexing (OFDM) communication system allocates approximately 16 to 64 random access sequences to each cell. Hence, the base station may require a corresponding 16 to 64 IFFT operation modules to calculate and send responses of the random access sequences to the mobile station within a designated time, which may further aggravate the structure and complexity of a receiver.

### SUMMARY OF THE INVENTION

To address the above-discussed deficiencies of the prior art, it is a primary aspect of the present invention to provide an apparatus and a method for receiving a random access signal in a base station of a wireless communication system.

Another aspect of the present invention is to provide an apparatus and a method for reducing calculations according to reception of a random access signal in a base station of a wireless communication system.

Yet another aspect of the present invention is to provide an apparatus and a method for reducing computation according to reception of a random access signal in a base station of a wireless communication system.

Still another aspect of the present invention is to provide an apparatus and a method for reducing complexity according to reception of a ranging signal in a base station of a wireless communication system.

A further aspect of the present invention is to provide an apparatus and a method for reducing calculations according to reception of a ranging signal in a base station of a wireless communication system.

A further aspect of the present invention is to provide an apparatus and a method for reducing complexity according to reception of a Physical Random Access CHannel (PRACH) signal in a base station of a wireless communication system.

A further aspect of the present invention is to provide an apparatus and a method for reducing calculations according to reception of a PRACH signal in a base station of a wireless communication system.

According to one aspect of the present invention, an apparatus for receiving a random access signal in a base station of a wireless communication system includes a control signal extractor for extracting the random access signal from a signal received via an antenna, at least one sequence generator for generating at least one sequence by multiplying the random access signal by at least one candidate sequence, a sequence selector for selecting at least one sequence to detect by differentially correlating sequence components at an adjacent subcarrier location with respect to each sequence, and a detector for detecting the at least one selected sequence.

According to another aspect of the present invention, a method for receiving a random access signal in a base station of a wireless communication system includes extracting the random access signal from a received signal, generating at least one sequence by multiplying the random access signal by at least one candidate sequence, selecting at least one sequence to detect by differentially correlating sequence components at an adjacent subcarrier location with respect to each sequence, and detecting the at least one selected sequence.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an example receiver of a base station according to one embodiment of the present invention;

FIG. 2 illustrates an example sequence selector according to one embodiment of the present invention;

FIG. 3 illustrates an example sequence selector according to another embodiment of the present invention;

FIG. 4 illustrates an example receiver of the base station according to another embodiment of the present invention;

FIG. 5 illustrates an example method for receiving a random access signal in a base station according to one embodiment of the present invention; and

FIG. 6 illustrates an example method for receiving the random access signal in the base station according to another embodiment of the present invention.

Throughout the drawings, like reference numerals will be understood to refer to like parts, components and structures.

### DETAILED DESCRIPTION OF THE INVENTION

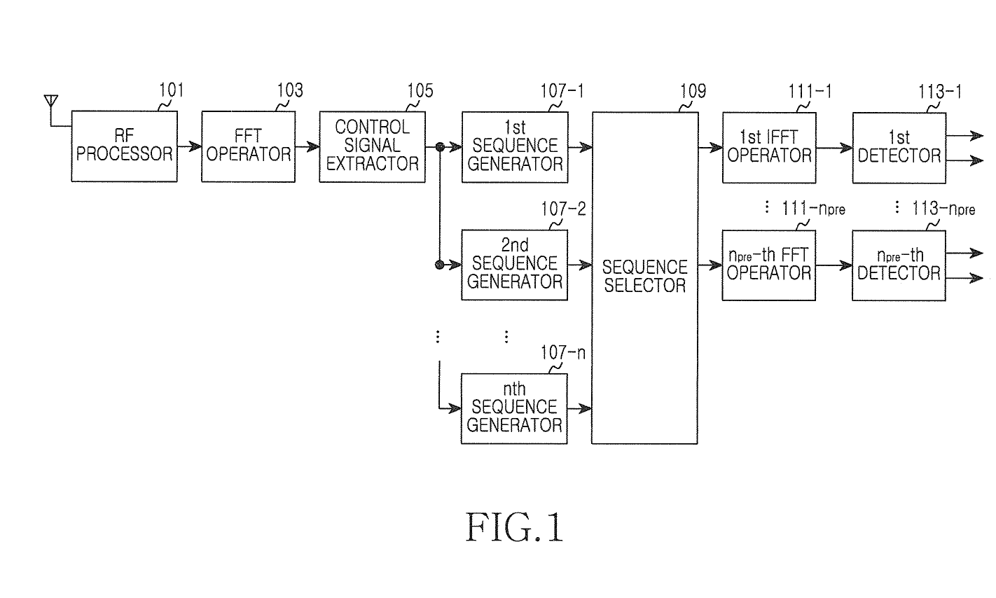

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Embodiments of the present invention will be described herein below with reference to the accompanying drawings. In the following description, well-known functions or constructions are not described in detail since they would obscure the invention in unnecessary detail. Terms described below, which are defined considering functions in the present invention, can be different depending on user and operator's intention or practice. Therefore, the terms should be defined on the basis of the disclosure throughout this specification.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for receiving a random access signal in a base station of a wireless communication system. Herein, the random access signal is used by a mobile station to request call access such as initial network entry or hand-off, and includes a ranging signal or a Physical Random Access CHannel (PRACH) signal.

As will be described in detail below, certain embodiments of the base station of the wireless communication system may decrease the number of inverse fast Fourier transformers by reducing complexity and calculations for receiving the random access signal as shown in FIG. 1.

FIG. 1 illustrates an example receiver of the base station according to one embodiment of the present invention.

As shown in FIG. 1, the receiver of the base station includes a Radio Frequency (RF) processor 101, a Fast Fourier Transform (FFT) operator 103, a control signal extractor 105, sequence generators 107-1 through 107-n, a sequence selector 109, Inverse Fast Fourier Transform (IFFT) operators 111-1 through 111-nₚᵣₑ, and detectors 113-1 through 113-nₚᵣₑ.

The RF processor 101 processes an RF signal received by an antenna. For example, the RF processor 101 converts the RF signal received by the antenna to a baseband signal. Next, the RF processor 101 converts the baseband signal to a digital signal and outputs the digital signal.

The FFT operator 103 converts the signal outputted from the RF processor 101 to a frequency-domain signal using a FFT.

The control signal extractor 105 extracts a random access signal from the frequency-domain signal output from the FFT operator 103.

The sequence generators 107-1 through 107-n generate sequences by multiplying the random access signal outputted from the control signal extractor 105 using candidate sequences. For example, the output signal of the FFT operator 103 may perform the transform function given by Equation 1. The sequence generators 107-1 through 107-n multiply the random access signal by different candidate sequences.

Yₖ=HₖCₖ^{(p)}+Nₖ (1)

Yₖ denotes the random access signal of a k-th subcarrier, Hₖ denotes a wireless Channel Frequency Response (CFR) of the k-th subcarrier, Cₖ^{(p)} denotes the random access sequence carried by the k-th subcarrier, Nₖ denotes noise, and k denotes a subcarrier index in the frequency axis. Herein, a mobile station can randomly select and transmit one of the sequences from Cₖ⁽¹⁾ to Cₖ^{(M)} of the random access signal. Accordingly, the mobile station can represent the p-th sequence randomly selected and transmitted, as Cₖ^{(p)}.

When the output signal of the FFT operator 103 is generated as the sequence in the m-th sequence generator 107-m in Equation 1, the sequence generated by the m-th sequence generator 107-m may be given by Equation 2.

Zₖ^{(m)}=conj(Cₖ^{(m)})Yₖ (2)

Zₖ^{(m)} denotes the sequence generated by the m-th sequence generator 107-m, Yₖ denotes the random access signal of the k-th subcarrier, conj( ) denotes a conjugate value of a complex number, and Cₖ^{(m)} denotes the candidate sequence multiplied by the m-th sequence generator 107-m to the random access signal extracted by the control signal extractor 105.

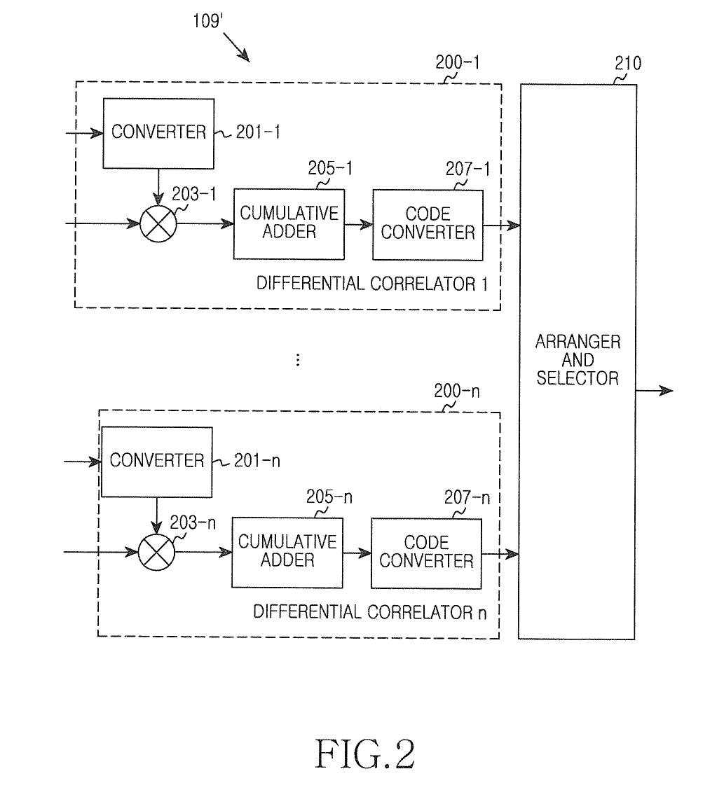

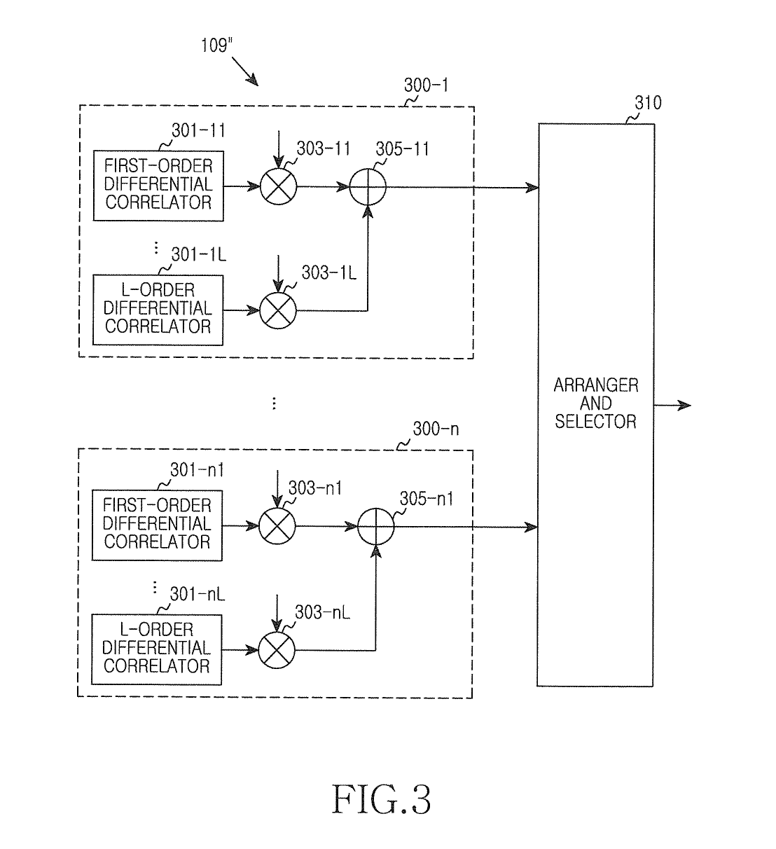

The sequence selector 109 selects nₚᵣₑ-ary sequences by differentially correlating the random access sequences output from the sequence generators 107-1 through 107-n. For example, the sequence selector 109 is constituted as shown in FIG. 2 or FIG. 3 to select the nₚᵣₑ-ary sequences highly likely to be received.

The IFFT operators 111-1 through 111-nₚᵣₑ apply the IFFT to the nₚᵣₑ-ary sequences selected by the sequence selector 109. For example, when the sequence generators 107-1 through 107-n multiply the same candidate sequence as the random access sequence sent from the mobile station over the random access channel, the output of the corresponding sequence generator leaves only the CFR and noise. Thus, when the IFFT operators 111-1 through 111-nₚᵣₑ apply the IFFT to the nₚᵣₑ-ary sequences, the output of the IFFT operators 111-1 through 111-nₚᵣₑ includes a Channel Impulse Response (CIR).

The detectors 113-1 through 113-nₚᵣₑ select a maximum value from the IFFT sequences output from the IFFT operators 111-1 through 111-nₚᵣₑ. The detectors 113-1 through 113-nₚᵣₑ select the maximum value of the same code by squaring or applying the absolute value to the IFFT sequences outputted from the IFFT operators 111-1 through 111-nₚᵣₑ.

When the maximum value is greater than a reference threshold, the detectors 113-1 through 113-nₚᵣₑ determine that the corresponding random access sequence is transmitted, and thus checks a time synchronization error by considering the location of the maximum value.

FIG. 2 illustrates an example sequence selector 109′ according to one embodiment of the present invention.

As shown in FIG. 2, the sequence selector 109′ includes multiple differential correlators 200-1 through 200-n, and an arranger and selector 210. Since the differential correlators 200-1 through 200-n have the same structure, the first differential correlator 200-1 will be explained.

The first differential correlator 200-1 differentially correlates and accumulates sequence components of adjacent subcarriers with respect to the sequence output from the first sequence generator 107-1. For example, the first differential correlator 200-1 includes a converter 201-1, a multiplier 203-1, a cumulative adder 205-1, and a code converter 207-1.

For the differential operation, the converter 201-1 converts the sequence component at the k-th subcarrier location in the sequence generated by the first sequence generator 107-1, to the conjugate value. For example, the converter 201-1 generates the conjugate value of Zₖ⁽¹⁾.

The multiplier 203-1 generates a k-th differential correlation value by multiplying the conjugate value of Zₖ⁽¹⁾ output from the converter 201-1 and the sequence component of Z₍ₖ₊₁₎⁽¹⁾. For example, the multiplier 203-1 generates the differential correlation value based on Equation 3.

$${Z}_{k + 1}^{( m )} * conj ( {Z}_{k}^{( m )} ) \approx {H}_{k + 1}^{( m )} * conj ( {H}_{k}^{( m )} ) \approx {H}^{( m )} * conj ( {H}_{k}^{( m )} ) \qquad ( 3 )$$

Zₖ₊₁^{(m)} denotes the sequence component at the (k+1)-th subcarrier location in the sequence generated by the m-th sequence generator 107-m, conj(Zₖ^{(m)}) denotes the conjugate value of the sequence component at the k-th subcarrier location in the sequence generated by the m-th sequence generator 107-m, Hₖ₊₁ denotes the wireless CFR of the (k+1)-th subcarrier, Hₖ denotes the wireless CFR of the k-th subcarrier, and conj(Hₖ) denotes the conjugate value of the wireless CFR of the k-th subcarrier.

The cumulative adder 205-1 accumulates and adds the differential correlation values generated by the multiplier 203-1. That is, when the random access signal uses k-ary frequency subcarriers, the subcarrier index k indicating the location of the subcarrier ranges from 0 to (k−1). In this case, the cumulative adder 205-1 accumulates and adds the differential correlation value from 0 to (k−2).

The code converter 207-1 converts the code of the accumulated value output from the cumulative adder 205-1 such that the accumulated values output from the differential correlators 200-1 through 200-n have the same code. For example, the code converter 207-1 converts the code of the accumulated value output from the cumulative adder 205-1 through the absolute value operation or the square operation

The arranger and selector 210 arranges the accumulated values output from the differential correlators 200-1 through 200-n. Next, the arranger and selector 210 selects nₚᵣₑ-ary accumulated values in the descending order from the arranged accumulated values.

In doing so, the sequence selector 109′ recognizes that the sequence having the selected nₚᵣₑ-ary accumulated values is detected, and thus sends the corresponding sequences to the IFFT operators 111-1 through 111-nₚᵣₑ respectively.

As described above, when it is assumed that the adjacent channel responses are approximately the same, the differential correlation value for the adjacent subcarrier can be represented as the power of the CFR. When the logically successive subcarriers are not physically adjacent, the corresponding value can be excluded using the cumulative addition because the same channel complex cannot be guaranteed.

When the receive signal includes the same random access sequence as the candidate sequence used by the sequence generators 107-1 through 107-n, the power of the CFR may have a relatively high value. Hence, the sequence selector 109′ can select the nₚᵣₑ-ary sequences having the relatively high accumulated value, as the sequence for the signal detection.

In the above embodiment, the sequence selector 109′ selects the sequence to detect through the differential correlation on the adjacent subcarrier.

Alternatively, the sequence selector 109′ may select the sequence to detect through L-order differential correlation as shown in FIG. 3.

FIG. 3 illustrates an example sequence selector 109″ according to another embodiment of the present invention.

As shown in FIG. 3, the sequence selector 109″ includes differential correlation blocks 300-1 through 300-n, and an arranger and selector 310. Since the differential correlation blocks 300-1 through 300-n have the same structure, the first differential correlation block 300-1 will be explained below.

The first differential correlation block 300-1 accumulates L-ary differential correlation values of the sequence components at the adjacent subcarrier location with respect to the sequence output from the first sequence generator 107-1. For example, the first differential correlation block 300-1 includes differential correlators 301-11 through 301-1L, multipliers 303-11 through 303-1L, and an adder 305-11.

The differential correlators 301-11 through 301-1L differentially correlate the sequence component at the adjacent subcarrier location according to the corresponding order. For example, the first differential correlator 301-11 calculates the accumulated value of the differential correlation of the sequence component of Zₖ⁽¹⁾ and the sequence component of Z₍ₖ₊₁₎⁽¹⁾ similar to the differential correlator 200-1 of FIG. 2. For example, a second differential correlator calculates the accumulated value of the differential correlation of the sequence component of Zₖ⁽¹⁾ and the sequence component of Z₍ₖ₊₂₎⁽¹⁾. For example, the L-th differential correlator 301-1L calculates the accumulated value of the differential correlation of the sequence component of Zₖ⁽¹⁾ and the sequence component of Z_{(+L)}⁽¹⁾.

The multipliers 303-11 through 303-1L apply a corresponding weight to the accumulated value output from each of the differential correlators 301-11 through 301-1L. For example, the multipliers 303-11 through 303-1L apply a higher weight as the location of the subcarriers for the differential correlation is closer together. That is, among the multipliers 303-11 through 303-1L, the first multiplier 303-11 is allocated the highest weight to apply the weight to the first differential correlator 301-11.

The adder 305-11 calculates the sum of the accumulated values weighted by the multipliers 303-11 through 303-1L.

The arranger and selector 310 arranges the sum of the accumulated values output from the differential correlation blocks 300-1 through 300-n. Next, the arranger and selector 310 selects the sum of the nₚᵣₑ-ary accumulated values from the greatest sum of the accumulated values among the arranged accumulated value sums.

In doing so, the sequence selector 109″ recognizes that the sequences having the sum of the selected nₚᵣₑ-ary accumulated values is detected, and thus sends the corresponding sequence to the IFFT operators 111-1 through 111-nₚᵣₑ.

In this embodiment, the receiver of the base station includes the nₚᵣₑ-ary IFFT operators 111-1 through 111-nₚᵣₑ. Accordingly, the receiver selects and detects only the nₚᵣₑ-ary sequences.

Alternatively, the receiver of the base station may include as many IFFT operators as the number of sequence generators. Also, the receiver may control the number of the IFFT operators to drive according to an average number of the received sequences.

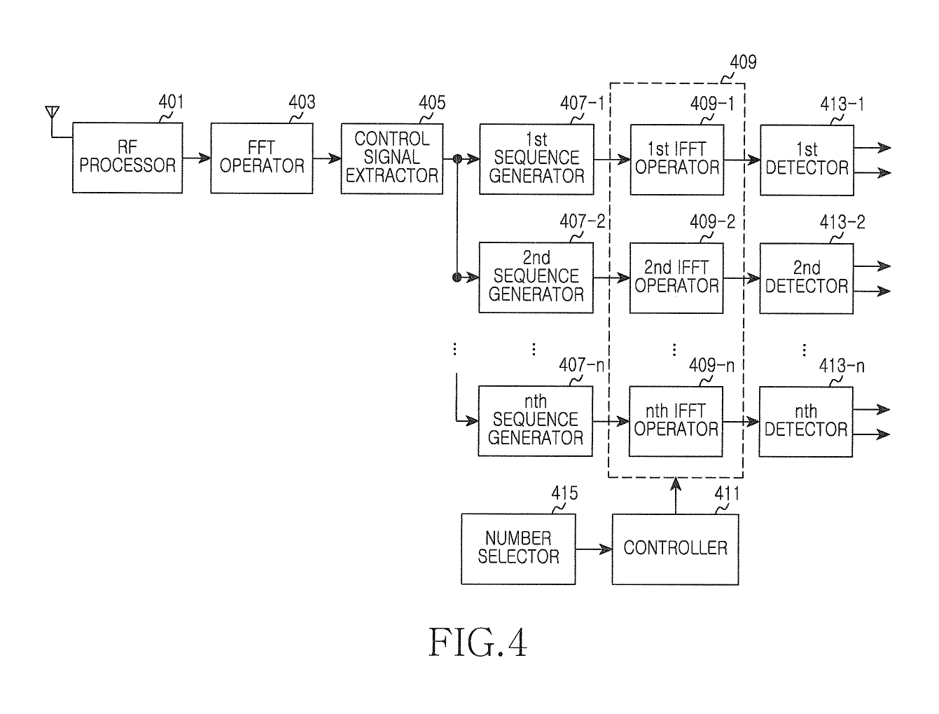

FIG. 4 illustrates an example receiver of the base station according to another embodiment of the present invention.

As shown in FIG. 4, the receiver of the base station includes an RF processor 401, an FFT operator 403, a control signal extractor 405, multiple sequence generators 407-1 through 407-n, IFFT operators 409-1 through 409-n, a controller 411, detectors 413-1 through 413-n, and a number selector 415.

The RF processor 401 processes an RF signal received via an antenna. For example, the RF processor 401 converts the RF signal received via the antenna to a baseband signal. Next, the RF processor 401 converts the baseband signal to a digital signal and outputs the digital signal.

The FFT operator 403 converts the signal output from the RF processor 401 to a frequency-domain signal using a FFT.

The control signal extractor 405 extracts the random access signal from the frequency-domain signal output from the FFT operator 403.

The sequence generators 407-1 through 407-n generate the sequence by multiplying the random access signal output from the control signal extractor 405 by candidate sequences respectively. In doing so, the sequence generators 407-1 through 407-n multiply different candidate sequences and the random access signal.

The IFFT operators 409-1 through 409-n apply an IFFT to the sequence output from the sequence generators 407-1 through 407-n. Only the IFFT operators 409-1 through 409-n selected by the controller 411 are driven.

The controller 411 selects the sequences in the number determined by the number selector 415. For example, the controller 411 can be embodied as shown in FIG. 2 to select the sequence to detect by differentially correlating the sequence components at the adjacent subcarrier location with respect to each sequence. For example, the controller 411 may be embodied as shown in FIG. 3 to select the sequence to detect by apply the L-order differential correlation to the sequence components at the adjacent subcarrier location with respect to each sequence.

The number selector 415 selects the number of the sequences to detect. For example, the number selector 415 determines the average number of the sequences received for a certain time, as the number of the sequences to detect.

The detectors 413-1 through 413-n select a maximum value from the IFFT sequences output from the IFFT operators 409-1 through 409-n. The detectors 413-1 through 413-n select the maximum value of the same code by squaring or applying the absolute value to the IFFT sequences output from the IFFT operators 409-1 through 409-n.

When the maximum value is greater than a reference threshold, the detectors 413-1 through 413-n determine that the corresponding random access sequence is transmitted, and thus checks the time synchronization error by considering the location of the maximum value.

In this embodiment, the receiver includes the IFFT operators 409-1 through 409-n as many as the sequence generators 407-1 through 407-n.

In other exemplary embodiment, the present invention is equally applicable to the receiver which includes the IFFT operators 409-1 through 409-m smaller than the sequence generators 407-1 through 407-n in the number. That is, in the receiver of FIG. 1, the number of the sequences to detect can be regulated according to the average number of the received sequences.

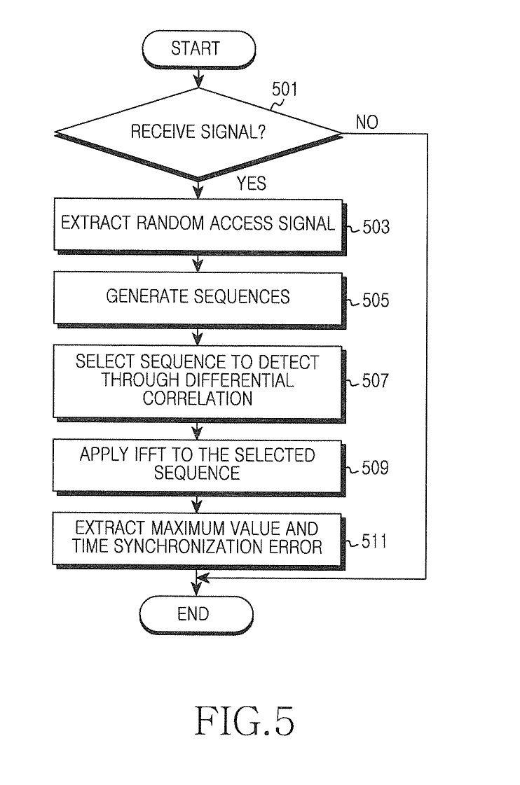

FIG. 5 illustrates an example method for receiving the random access signal in the base station according to one embodiment of the present invention.

In FIG. 5, the receiver checks whether the signal is received from the mobile station in step 501. For example, the receiver determines whether the signal is received using the random access channel.

Upon receiving the signal using the random access channel, the receiver extracts the random access signal from the received signal in step 503. For example, the receiver extracts the random access signal from the frequency-domain signal converted through the FFT.

In step 505, the receiver generates the plurality of the sequences using the extracted random access signal. For example, when n-ary candidate sequences are allocated to the base station, the receiver generates n-ary sequences by multiplying the random access signal by the n-ary candidate sequences respectively.

In step 507, the receiver selects at least one sequence detected by differentially correlating the sequence components at the adjacent subcarrier location with respect to the sequences. For example, the receiver calculates the accumulated value of the differential correlation of the sequence components at the adjacent subcarrier location with respect to each sequence as shown in FIG. 2 or FIG. 3. Next, the receiver selects nₚᵣₑ-ary sequences having the great accumulated value. In doing so, the receiver can select the sequences as many as the IFFT operators to be used to detect the sequence, or select the sequences for the signal detection by considering the average number of the received sequences.

In step 509, the receiver applies the IFFT to the at least one selected sequence.

In step 511, the receiver extracts the maximum value and the time synchronization error from the IFFT-processed sequence with respect to each sequence. For example, the receiver extracts the maximum value from the IFFT-processed sequence with respect to each sequence. In doing so, when the maximum value is greater than the reference threshold, the receiver determines that the corresponding random access sequence is transmitted, and thus checks the time synchronization error by considering the location of the corresponding maximum value.

Next, the receiver finishes this process.

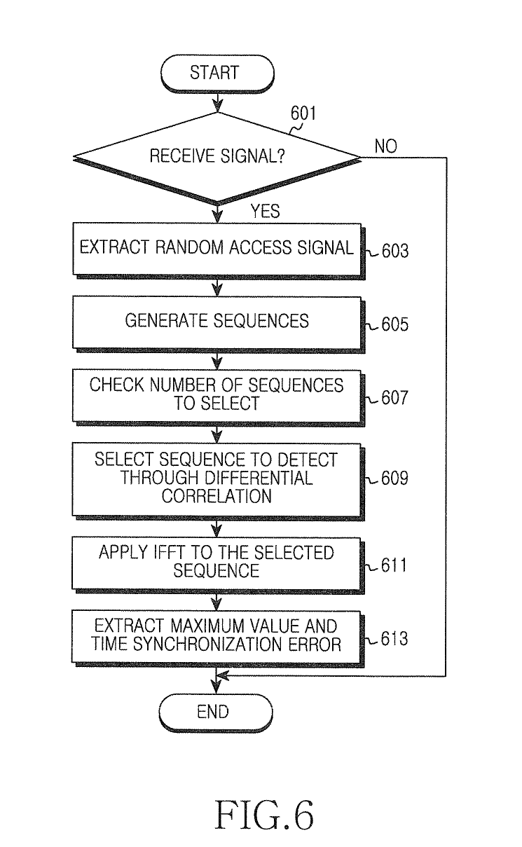

FIG. 6 illustrates an example method for receiving the random access signal in the base station according to another embodiment of the present invention. In the embodiment described with respect to FIG. 5, the receiver selects and detects the fixed number of sequences. Alternatively in this embodiment, the receiver adaptively changes the number of the sequences.

In FIG. 6, the receiver checks whether the signal is received from the mobile station in step 601. For example, the receiver determines whether the signal is received using the random access channel.

Upon receiving the signal using the random access channel, the receiver extracts the random access signal from the received signal in step 603. For example, the receiver extracts the random access signal from the frequency-domain signal converted through the FFT.

In step 605, the receiver generates the sequences using the extracted random access signal. For example, when n-ary candidate sequences are allocated to the base station, the receiver generates n-ary sequences by multiplying the random access signal and the n-ary candidate sequences respectively.

In step 607, the receiver checks the number of the sequences to detect. For example, the receiver determines the number of the sequences to detect by taking into account the average number of the sequences received for a certain time.

In step 609, the receiver selects the sequences in the number determined in step 607 by differentially correlating the sequence components at the adjacent subcarrier location with respect to the sequences. For example, the receiver calculates the accumulated value of the differential correlation of the sequence components at the adjacent subcarrier location with respect to each sequence as shown in FIG. 2 or FIG. 3. Next, the receiver selects P-ary sequences having the great accumulated value. Herein, P denotes the number of the sequences determined in step 607.

In step 611, the receiver applies the IFFT to the selected sequence.

In step 613, the receiver extracts the maximum value and the time synchronization error from the IFFT-processed sequence with respect to each sequence. For example, the receiver extracts the maximum value from the IFFT-processed sequence with respect to each sequence. In doing so, when the maximum value is greater than the reference threshold, the receiver determines that the corresponding random access sequence is transmitted, and thus checks the time synchronization error by considering the location of the corresponding maximum value.

Next, the receiver finishes this process.

In this embodiment, the equation relating to the random access signal and sequence does not include time synchronization error information, yet the random access signal and sequence include the time synchronization error information.

As set forth above, the base station of the wireless communication system limits the number of the random access sequences of which the transmission is to be checked. Therefore, the complexity in receiving the uplink random access signal can be reduced in some embodiments.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A random access signal receiving method for a base station of a wireless communication system, the method comprising:
extracting a random access signal from a received signal;
generating at least one sequence by multiplying the random access signal by at least one candidate sequence;
selecting at least one sequence to detect by differentially correlating sequence components at an adjacent subcarrier location with respect to each sequence; and
detecting the at least one selected sequence.

2. The method of claim 1, wherein the random access signal comprises at least one of a ranging signal and a Physical Random Access CHannel (PRACH) signal.

3. The method of claim 1, wherein the selecting the sequence comprises:
differentially correlating the sequence components at the adjacent subcarrier location with respect to each sequence; and
selecting at least one sequence to detect by comparing differential correlation values of the sequences.

4. The method of claim 3, further comprising:
after differentially correlating the sequence components, calculating an accumulated sum of the differential correlation of each sequence,
wherein the selecting of the at least one sequence comprises selecting at least one sequence to detect by comparing the accumulated sum of the sequences.

5. The method of claim 1, further comprising:
determining the number of sequences to detect before selecting the sequence.

6. The method of claim 5, wherein the determining the number of the sequences comprises:
determining the number of the sequences to detect by considering an average number of sequences received during a reference time.

7. The method of claim 1, wherein the detecting the at least one selected sequence comprises:
applying Inverse Fast Fourier Transform (IFFT) to each of the at least one selected sequence; and
selecting a maximum value with respect to the IFFT-processed sequences.

8. The method of claim 7, further comprises:
after selecting the maximum value, estimating a time synchronization error by considering a location of the maximum value with respect to at least one sequence having the maximum value greater than a reference threshold.

9. The method of claim 7, further comprising:
after applying the IFFT, converting a code of the IFFT-processed sequences to the same code through at least one of an absolute value operation or a square operation,
wherein the selecting of the maximum value comprises selecting the maximum value with respect to the IFFT-processed sequences of which the code is converted to the same code.

10. A random access signal receiving apparatus for a base station of a wireless communication system, the apparatus comprising:
a control signal extractor configured to extract a random access signal from a signal received via an antenna;
at least one sequence generator configured to generate at least one sequence by multiplying the random access signal by at least one candidate sequence;
a sequence selector configured to select at least one sequence to detect by differentially correlating sequence components at an adjacent subcarrier location with respect to each sequence; and
a detector configured to detect the at least one selected sequence.

11. The apparatus of claim 10, wherein the random access signal comprises at least one of a ranging signal and a Physical Random Access CHannel (PRACH) signal.

12. The apparatus of claim 10, wherein the sequence selector comprises:
at least one differential correlator configured to differentially correlate the sequence components at the adjacent subcarrier location with respect to each sequence; and
a selector configured to select at least one sequence to detect by comparing differential correlation values of the sequences.

13. The apparatus of claim 12, wherein the differential correlator comprises:
a converter configured to generate a conjugate value of a sequence component at a k-th subcarrier location;
a multiplier configured to generate a k-th differential correlation value by multiplying the sequence at a (k+1)-th subcarrier location and the conjugate value; and
an adder configured to accumulate a differential correlation value at every adjacent subcarrier location with respect to the corresponding sequence.

14. The apparatus of claim 10, further comprising:
a number determiner configured to determine the number of sequences to detect before selecting the sequence, wherein the sequence selector selects the sequences in the number determined by the number determiner.

15. The apparatus of claim 14, wherein the number determiner is configured to determine the number of the sequences to detect by considering an average number of sequences received for a reference time.

16. The apparatus of claim 10, wherein the detector comprises:
at least one Inverse Fast Fourier Transform (IFFT) operator configured to apply an IFFT to each sequence selected by the sequence selector; and
a maximum value extractor configured to select a maximum value with respect to the IFFT-processed sequences.

17. The apparatus of claim 16, wherein the maximum value extractor is configured to, after selecting the maximum value of the IFFT-processed sequences, estimate a time synchronization error by considering a location of the maximum value with respect to at least one sequence having the maximum value greater than a reference threshold.

18. The apparatus of claim 16, further comprising:
a code converter configured to, after applying the IFFT, convert a code of the IFFT-processed sequences to the same code through an absolute value operation or a square operation, wherein the maximum value extractor selects the maximum value of the IFFT-processed sequences of which the code is converted to the same code.

19. Code implemented on a computer-readable medium, when executed by a processor, operable to perform at least the following:
extract a random access signal from a received signal;
generate at least one sequence by multiplying the random access signal by at least one candidate sequence;
select at least one sequence to detect by differentially correlating sequence components at an adjacent subcarrier location with respect to each sequence; and
detect the at least one selected sequence.

20. The code of claim 19, further operable to perform:
differentially correlate the sequence components at the adjacent subcarrier location with respect to each sequence; and
select at least one sequence to detect by comparing differential correlation values of the sequences.
